(19) United States
(12) Patent Application Publication
(10) Pub. No.: US 2026/0094551 A1
(43) Pub. Date: Apr. 2, 2026

(54) VEHICLE CONTROL APPARATUS AND CONTROL METHOD THEREOF

(71) Applicant: HYUNDAI MOBIS CO., LTD., Seoul (KR)

(72) Inventor: Seung Jae KIM, Yongin-Si (KR)

(73) Assignee: HYUNDAI MOBIS CO., LTD., Seoul (KR)

(21) Appl. No.: 19/232,959

(22) Filed: Jun. 10, 2025

(30) Foreign Application Priority Data
Sep. 30, 2024 (KR) 10-2024-0133129

(51) Int. Cl. G09G 3/00; B60K 35/215; B60K 35/22

(52) U.S. Cl. CPC G09G 3/035; B60K 35/215; B60K 35/223; B60K 2360/128; G09G 2340/0471; G09G 2340/14; G09G 2354/00; G09G 2380/10

(57) ABSTRACT

A vehicle control apparatus includes a display device provided in a body. The display device includes a display configured to display visual information and a driving unit configured to change at least one of a shape of the display and a position of the display according to a mode, in which the body further includes a hidden area selectively covered by a lower portion of the display. The driving unit exposes or does not expose the hidden area by changing the position of the display, the mode includes an exposure mode in which the hidden area is exposed and a non-exposure mode in which the hidden area is not exposed. An arrangement of one or more buttons of the hidden area in the exposure mode is identical to arrangement of one or more buttons of the partial area of the display in the non-exposure mode.

### CROSS-REFERENCE TO RELATED APPLICATIONS

This application claims the benefit of Korean Patent Application No. 10-2024-0133129, filed on Sep. 30, 2024, which is hereby incorporated by reference as if fully set forth herein.

### TECHNICAL FIELD

The present disclosure relates to a vehicle control apparatus and a control method thereof, and more particularly, to a vehicle control apparatus and a control method thereof to flexibly use a display in a vehicle.

### BACKGROUND

Generally, various display apparatuses capable of displaying images and visual information are installed and used in vehicles. One of them may be installed around a driver's seat, for example, on a dashboard, in a vehicle.

If a size of a display screen provided by the display device installed on the dashboard is large, a variety of and a lot of information may be transmitted to a driver and/or an occupant through a single display screen, but the possibility of interference between the display screen and other devices installed in the vehicle may increase, obstructing a view of the driver and/or the occupant.

On the other hand, if the size of the display screen is small, information that may be provided through the single display screen may be reduced, whereas the possibility of interference between the display screen and the other devices installed in the vehicle may be low, reducing the possibility of obstructing the view of the driver and/or the occupant.

### SUMMARY

The present disclosure is proposed to solve the above-described problems and various problems related thereto, and aims to provide a vehicle control apparatus and a control method thereof to flexibly adjust a display installed in a vehicle.

The present disclosure also aims to provide a vehicle control apparatus and a control method thereof to change a position of a display according to a purpose for use of a screen, thereby making it possible to use a hidden area hidden by the display.

The present disclosure aims to provide a vehicle control apparatus and a control method thereof to display, in a hidden area, state information or a control function displayed in a partial area of a display when the hidden area is exposed.

The present disclosure aims to provide a vehicle control apparatus and a control method thereof to display, in a partial area of a display, state information or a control function of a hidden area when the hidden area becomes invisible shown due to movement of the display.

However, the present disclosure is not limited to the technical problems described above, and the scope of the embodiments may be expanded to other technical problems that may be construed by those of ordinary skill in the art based on the entire contents of the present document.

To achieve the foregoing objects and other advantages, a vehicle control apparatus includes a vehicle body and a display device provided in the vehicle body, in which the display device includes a display configured to display visual information and a driving unit configured to change at least one of a shape of the display and a position of the display according to a mode of the display.

According to embodiments, the vehicle body may further include a hidden area hidden by a partial area of the display, the driving unit may expose or not expose the hidden area by changing the position of the display, the mode may include an exposure mode in which the hidden area is exposed and a non-exposure mode in which the hidden area is not exposed, and arrangements of one or more buttons of the hidden area in the exposure mode may be identical to arrangements of one or more buttons of the partial area of the display in the non-exposure mode.

According to embodiments, when the mode is changed from the exposure mode to the non-exposure mode, the one or more buttons of the partial area of the display may be arranged identically to the arrangements of the one or more buttons of the hidden area.

According to embodiments, state information of the one or more buttons of the hidden area may be applied to the one or more buttons of the partial area of the display.

According to embodiments, when the mode is changed from the non-exposure mode to the exposure mode, the one or more buttons of the hidden area may be arranged identically to the arrangements of the one or more buttons of the partial area of the display.

According to embodiments, state information of the one or more buttons of the partial area of the display may be applied to the one or more buttons of a partial area of the hidden area.

According to embodiments, sizes of the one or more buttons of the hidden area in the exposure mode may be identical to sizes of the one or more buttons of the partial area of the display in the non-exposure mode.

According to embodiments, the hidden area may include one or more hard buttons or one or more soft buttons for controlling a function of the vehicle body.

According to embodiments, the hidden area may include one or more hard buttons or one or more soft buttons for controlling contents reproduced in the display.

According to embodiments, the driving unit may be further configured to change the shape of the display by folding or unfolding a part of the display at a specific angle according to the mode, and to change the position of the display by moving the display upwardly or downwardly through sliding.

According to embodiments, a display area of the display may be divided into a first area, a second area, and a third area arranged on a same surface, the second area may be positioned above the first area, and the third area may be positioned under the first area, at least one of the second area and the third area may be folded or unfolded at a specific angle by the driving unit, and a folding angle of the second area and a folding angle of the third area may be identical to or different from each other.

According to embodiments, a partial area of the display where the one or more buttons are displayed may correspond to the third area.

According to embodiments, the third area may be in a folded state in the non-exposure mode, the third area may be in an unfolded state in the exposure mode, and when the mode of the display is changed from the non-exposure mode to the exposure mode, the display may move upwardly a specific length through sliding, and when the mode of the display is changed from the exposure mode to the non-exposure mode, the display may move downwardly a specific length through sliding.

According to another aspect of the present disclosure, a vehicle control method includes providing a display and a hidden area hidden by a partial area of the display in a vehicle body and changing at least one of a shape of the display and a position of the display according to a mode of the display and changing the position of the display to expose or to avoid exposing the hidden area.

According to embodiments, the mode may include an exposure mode in which the hidden area is exposed and a non-exposure mode in which the hidden area is not exposed, and arrangements of one or more buttons of the hidden area in the exposure mode may be identical to arrangements of one or more buttons of the partial area of the display in the non-exposure mode.

According to embodiments, when the mode is changed from the exposure mode to the non-exposure mode, the one or more buttons of the partial area of the display may be arranged identically to the arrangements of the one or more buttons of the hidden area.

According to embodiments, state information of the one or more buttons of the hidden area may be applied to the one or more buttons of the partial area of the display.

According to embodiments, when the mode is changed from the non-exposure mode to the exposure mode, the one or more buttons of the hidden area may be arranged identically to the arrangements of the one or more buttons of the partial area of the display.

According to embodiments, state information of the one or more buttons of the partial area of the display may be applied to the one or more buttons of a partial area of the hidden area.

According to embodiments, sizes of the one or more buttons of the hidden area in the exposure mode may be identical to sizes of the one or more buttons of the partial area of the display in the non-exposure mode.

According to embodiments, the hidden area may include one or more hard buttons or one or more soft buttons for controlling a function of the vehicle body.

According to embodiments, the hidden area may include one or more hard buttons or one or more soft buttons for controlling contents reproduced in the display.

According to embodiments, the shape of the display may be changed by folding or unfolding a part of the display at a specific angle according to the mode, and the position of the display may be changed by moving the display upwardly or downwardly through sliding.

According to embodiments, a display area of the display may be divided into a first area, a second area, and a third area arranged on a same surface, the second area may be positioned above the first area, and the third area may be positioned under the first area, at least one of the second area and the third area may be folded or unfolded at a specific angle by the driving unit, and a folding angle of the second area and a folding angle of the third area may be identical to or different from each other.

According to embodiments, a partial area of the display where the one or more buttons are displayed may correspond to the third area.

According to embodiments, the third area may be in a folded state in the non-exposure mode, the third area may be in an unfolded state in the exposure mode, and when the mode of the display is changed from the non-exposure mode to the exposure mode, the display may move upwardly a specific length through sliding, and when the mode of the display is changed from the exposure mode to the non-exposure mode, the display may move downwardly a specific length through sliding.

According to embodiments, a computer program stored on a computer-readable recording medium may be combined with a computer, which is hardware, to perform the method.

The above-described solutions are merely some of various embodiments of the present specification, and those of ordinary skill in the art to which the present specification pertains may infer modified embodiments reflecting the technical features of the present specification through the overall intent described in the present specification.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 shows an example of a vehicle according to embodiments;

FIG. 2 shows an example of an inner side of a vehicle according to embodiments;

FIG. 3 is a block diagram of an example of a display device according to embodiments;

FIG. 4 shows an example of a display of a display device according to embodiments;

FIG. 5A to FIG. 5C show examples of shape change and position change of a display in first to third modes, according to embodiments;

FIG. 6A to FIG. 6C show an example in which information of a hidden area and information of a partial area of a flexible display are associated with each other in mode change, according to embodiments;

FIG. 7A and FIG. 7B show embodiments for a case where a hidden area is provided in the form of a display, in the present disclosure;

FIG. 8 is a flowchart of an example in which information of a hidden area and information of a partial area of a flexible display are associated with each other, according to embodiments;

FIG. 9A and FIG. 9B show other embodiments for a case where a hidden area is provided in the form of a display, in the present disclosure;

FIG. 10 is a flowchart of another example in which information of a hidden area and information of a partial area of a flexible display are associated with each other, according to embodiments;

FIG. 11A to FIG. 11C show another example in which information of a hidden area and information of a partial area of a flexible display are associated with each other in mode change, according to embodiments; and

FIG. 12 is a flowchart of another example in which information of a hidden area and information of a partial area of a flexible display are associated with each other, according to embodiments.

### DETAILED DESCRIPTION

Hereinafter, embodiments disclosed herein will be described in detail with reference to the accompanying drawings, and the same or similar components are given the same reference numerals, and redundant description thereof will be omitted. The following embodiment is to specify the present disclosure, but is not intended to limit the scope of rights of the present disclosure. It is interpreted that what those of ordinary skill in the art can easily infer from the detailed description and embodiments of the present disclosure falls within the scope of the rights of the present document.

The detailed description of the present document should not be construed in any way as restrictive and should be considered illustrative only. The scope of the present document should be determined by a reasonable interpretation of the appended claims, and all changes within the equivalent scope of the present document are included within the scope of the present document.

Meanwhile, blocks in the attached block diagrams or operations in the attached flowcharts may be implemented directly in hardware, implemented as software modules executed by hardware, or implemented by a combination thereof. In addition, the blocks in the attached block diagrams or the operations in the attached flowcharts may be interpreted as computer program instructions that are loaded into a processor or memory of data processible equipment, such as a general-purpose computer, a special-purpose computer, a portable laptop computer, a network computer, etc., and perform designated functions. As these computer program instructions may be stored in a memory provided in a computer device or a computer-readable memory, the functions described in the blocks of the block diagrams or the operations of the flowcharts may also be produced by an article that includes instruction means for executing the same. In addition, each block or operation may indicate a part of a module, segment or code including one or more executable instructions for executing specific logical function(s). In some alternative embodiments, the functions mentioned in the blocks or operations may be executed out of the specified order. For example, two blocks or operations shown in succession may be performed substantially simultaneously, may be performed in reverse order, or may be performed with some blocks or operations omitted.

The present disclosure relates to an apparatus for vehicle control and a control method of the apparatus, and aims to provide a display device including a foldable function and/or a sliding function. To this end, the display device according to the present disclosure may include a flexible display. In the present disclosure, the display device may be used interchangeably with a flexible display device for the same meaning, and the display may be used interchangeably with a flexible display for the same meaning.

In the present disclosure, the display may perform only the foldable function or both the foldable function and the sliding function at the same time, depending on a mode. In the present disclosure, the mode may be referred to as a driving mode or a display mode.

In the present disclosure, the foldable function may mean a function of a part of the display being folded or unfolded at a specific angle, and the sliding function may mean a function of a position of the display being changed as the display physically moves in a specific direction (e.g., up/down). In the present disclosure, a state of a part of the display being bent at a specific angle may be referred to as a folded state (or a folding state), and a state of the part of the display being unfolded may be referred to as an unfolded state (or an unfolding state). In the present disclosure, the shape (or form) of the display may be changed by the foldable function, and the position of the display may be changed by the sliding function.

The present disclosure aims to allow use of a hidden area hidden by the display by changing the position of the display through the sliding function according to a purpose for use.

In an embodiment, the hidden area may include one or more physical buttons in the present disclosure. A specific function of the vehicle and/or a specific function of the display may be performed by the one or more physical buttons of the hidden area. The physical button may mean a button having fixed position and size. In the present disclosure the physical button of the hidden area may be referred to as a hard button.

In another embodiment, the hidden area may be provided in the form of a display in the present disclosure. The display in the hidden area may display one or more soft buttons to enable the specific function of the vehicle and/or the specific function of the display to be executed. The soft button may refer to a button provided as a touch type on the screen of the display.

When the hidden area is provided in the form of a display, for convenience of description, the display having the foldable function will be referred to as a first display and the display in the hidden area will be referred to as a second display, in the present disclosure.

In the present disclosure, the hidden area will be referred to as a hard button area when the hidden area includes one or more physical buttons, and the hidden area will be referred to as a soft button area when the hidden area has the form of a display.

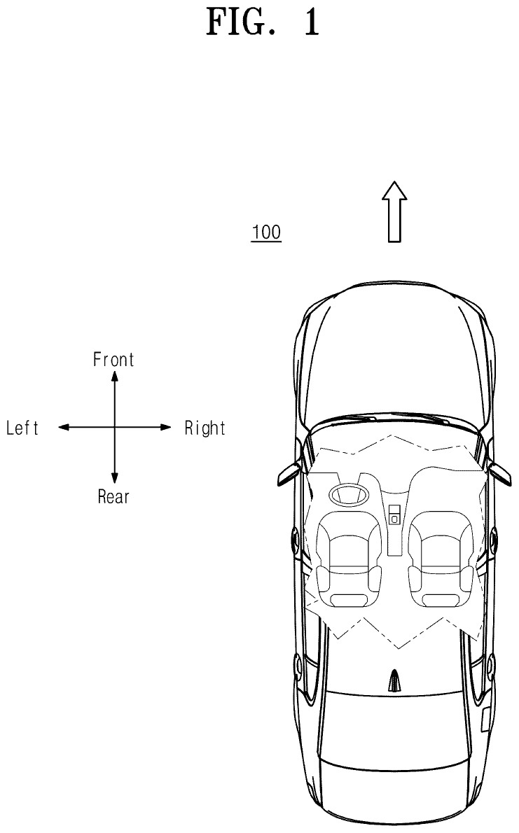

FIG. 1 shows an example of a vehicle according to embodiments. In the present disclosure, for convenience of description, a direction in which a vehicle 100 moves forward will be referred to as a front, and a left direction and a right direction will be identified with respect to the front, in which if the front is a 12 o'clock direction, a 3 o'clock direction or a periphery thereof will be defined as the right direction and a 9 o'clock direction or a periphery thereof will be defined as the left direction. A direction opposite to the front may be a rear. With respect to the center of the vehicle 100, a bottom direction will be referred to as a downward direction and a direction opposite thereto will be referred to as an upward direction. A surface arranged in the front will be referred to as a front surface, a surface arranged in the rear will be referred to as a rear surface, and a surface arranged in a lateral direction will be referred to as a side surface. A side surface in the left direction will be referred to as a left side surface, and a side surface in the right direction will be referred to as a right side surface.

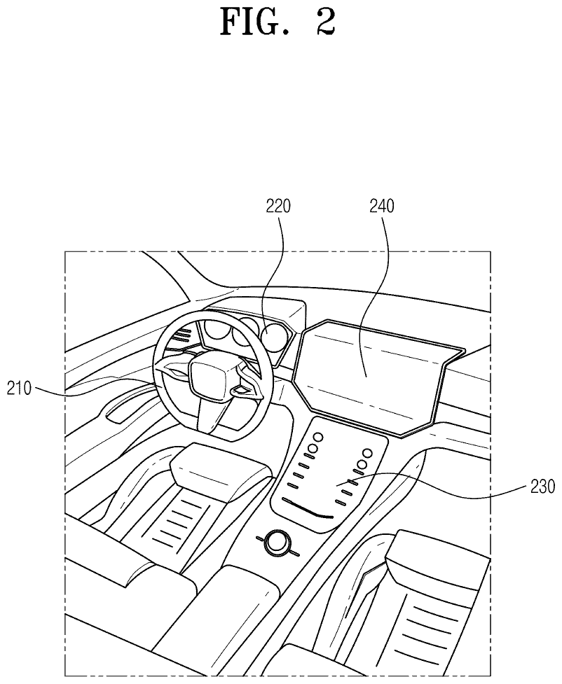

FIG. 2 shows an example of an inner side of a vehicle according to embodiments. In FIG. 2, there is inside the vehicle, a dashboard separating a driver's seat (and front occupant's seat) from an engine room. The dashboard may include a steering wheel 210, a cluster 220, a center fascia 230, a display device 240, etc. Components of the inner side of the vehicle and the dashboard shown in FIG. 2 are examples, and components of the inner side of the vehicle are not limited to the examples.

In FIG. 2, the steering wheel 210 may be configured to manipulate a vehicle direction, and the cluster 220 may display information required for driving, including a speedometer.

The center fascia 230 may be a panel board positioned between the driver's seat and the front occupant's seat in the center of the dashboard. Although not shown, a controller for vehicle control, an air vent, a cup holder, etc., may be installed in the center fascia 230. When the dashboard has a T shape, the center fascia 230 may serve as a wall separating the driver's seat from the front occupant's seat as well as a center console allowing the driver to change a gear and select the driving mode. In the present disclosure, the center fascia 230 does not have a planar shape. For example, the center fascia 230 may include a plurality of curved surfaces.

In the present disclosure, a plurality of display devices may be provided and may be installed at various positions. For example, the display devices may be installed on the dashboard, a room mirror, a rear seat, a front glass, a ceiling, etc.

In the present disclosure, a description will be made of a display 240 installed (or mounted) on the dashboard as an example.

In the present disclosure, the display device 240 may be positioned in the center of the dashboard, especially, at a position perpendicular to the center fascia 230.

In the present disclosure, the display 240 may include a flexible display having the foldable function and/or the sliding function. The flexible display including the foldable function and/or the sliding function will be described in detail later.

According to embodiments, in the display device 240, the display may include a plurality of display areas. In the present disclosure, a description will be made of an embodiment in which the display is divided into three display areas. This is merely an embodiment such that the number of display areas may be greater than or less than 3. According to embodiments, the plurality of display areas may respectively display independent images or two or more areas may display a single image in combination. The display may display one or more soft buttons for state display or control. The one or more soft buttons displayed on the display may have different shapes, sizes, colors, arrangements, positions, functions, etc., according to content displayed on the display or a current vehicle control state. For example, a shape or arrangement of a soft button may be different between when a soft button for adjusting an air conditioning system is displayed and when a soft button for media playback is displayed. That is, the shape of the soft button may be changed variously according to a use condition or need of the display, unlike the physical hard button.

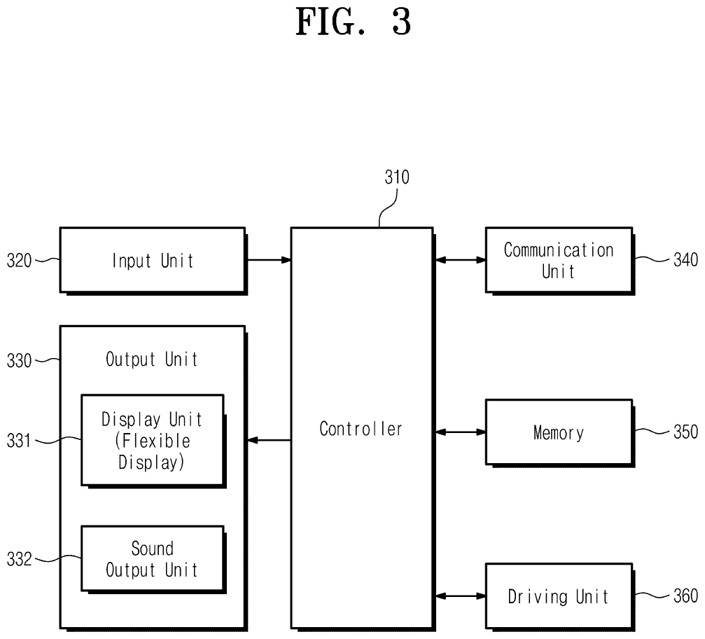

FIG. 3 is a block diagram of an example of a display device according to embodiments.

In FIG. 3, the display device may include a controller 310, an input unit 320, an output unit 330, a communication unit 340, a memory 350, and a driving unit 360. Components of FIG. 3 may correspond to hardware, software, a processor, and/or a combination thereof. In FIG. 3, an execution order of each block may be changed, and some blocks may be omitted and newly added.

According to embodiments, the input unit 320 may receive an operation command of various functions that are executable in the vehicle. The input unit 320 may receive a command for controlling the mode of the display from a user. In the present disclosure, the input unit 320 may include one or more cameras and/or sensors for receiving an image signal, a microphone for receiving an audio signal, and a user input unit (e.g., a touch key, a mechanical key, etc.) for receiving a command from the user. The input unit 320 may also receive information of a destination through texts or voice in execution of a navigation mode.

According to embodiments, the output unit 330 may generate an output related to vision, hearing, etc., and may include a display unit 331 for displaying visual information and a sound output unit 332 for outputting auditory information.

According to embodiments, the display unit 331 may include a flexible display, and visually display information about a function being executed in the vehicle and information input by the user. According to embodiments, the flexible display may be implemented by at least one of a liquid crystal display (LCD), a thin-film transistor liquid-crystal display (TFT LCD), an organic light-emitting diode (OLED), a three-dimensional (3D) display, and an electronic (e)-ink display. In the present disclosure, the display unit 331 may display information required for controlling various devices used in driving of the vehicle or an operation of the vehicle, information required for providing convenience to a vehicle occupant, or entertainment content. In the present disclosure, the entertainment content may include still images, moving images, games, etc. In the present disclosure, texts, images, graphic, etc., displayed on the display will be referred to as visual information.

In the present disclosure, a detailed description of the display unit 331 will be provided later.

According to embodiments, the sound output unit 332 may include a speaker, output the entire information being displayed on the display unit 331 or a part thereof in the form of sound or voice, and output the navigation information, etc., in the form of sound or voice. The sound output unit 332 may output audio of content being displayed on the display unit 331 or output a state of the vehicle, a risk situation, etc., in the form of audio.

According to embodiments, the communication unit 340 may include one or more wireless communication modules that enable wireless communication between the display device 240 and a wireless communication system, the display device 240 and another display device in the same vehicle, between the display device 240 and a display device of another vehicle, or between the display device 240 and an external server. In the present disclosure, the one or more wireless communication modules may support various wireless communications schemes such as wireless fidelity (Wi-Fi), wireless broadband (WiBro), a global system for mobile communication (GSM), code division multiple access (CDMA), wideband code division multiple access (WCDMA), a universal mobile telecommunications system (UMTS), time division multiple access (TDMA), Long Term Evolution (LTE), 4th-Generation (4G), 5th-Generation (5G), 6th-Generation (6G), etc. The communication unit 340 may include a short-range communication module. The short-range communication module may support short-range communication by using at least one of Bluetooth, radio frequency identification (RFID), infrared data association (IrDA), ultra-wideband (UWB), ZigBee, near field communication (NFC), Wi-Fi, Wi-Fi Direct, and wireless universal serial bus (USB). The short-range communication module may form wireless area networks to perform short-range communication between the vehicle and at least one external device. For example, a mobile terminal of the user in the vehicle and the vehicle may be paired with each other automatically or by user's execution of an application.

According to embodiments, the communication unit 340 may further include a global positioning system (GPS) module. The GPS module may obtain the position of the vehicle by using a signal from a GPS satellite, and the obtained position of the vehicle may be used for navigation, etc.

According to embodiments, the communication unit 340 may receive a broadcasting signal and/or broadcasting-related information from an external broadcasting management server through a broadcasting channel. The broadcasting channel may include a satellite channel and/or a terrestrial channel. The broadcasting signal may include not only a TV broadcasting signal, a radio broadcasting signal, and a data broadcasting signal, but also a broadcasting signal in a form where the data broadcasting signal is combined with the TV broadcasting signal or the radio broadcasting signal. The broadcasting-related information may mean information related to a broadcasting channel, a broadcasting program, or a broadcasting service provider. The received broadcasting signal and/or broadcasting-related information may be provided to the user in the vehicle through the display unit 331 and/or the sound output unit 332 of the output unit 330, or may be stored in the memory 350, under control of the controller 310.

According to embodiments, the memory 350 may store data supporting various functions of the display device 240. The memory 350 may store a number of application programs or applications driven by the display device 240, and data and instructions for operations of the display device 240. At least some of the application programs may be downloaded from an external server through wireless communication of the communication unit 340. At least some of the application programs may be present on the display device 240 from the time of shipment for fundamental functions (e.g., call incoming/outgoing functions, a message reception function, a sending function) of the display device 240. The application program may be stored in the memory 350, may be installed on the display device 240, and may be driven to perform an operation (or function) of the display device 240 by means of the controller 310. In the present disclosure, the memory 350 may store map data for implementing the navigation function. The map data may be stored by detail at the time of shipment of the vehicle. The map data may be received from the external device or updated through the communication unit 340.

According to embodiments, the driving unit 360 may fold/unfold a part of the display included in the display unit 331 and/or slide the entire display up/down, under control of the controller 310.

According to embodiments, the controller 310 may control an overall operation of each unit (e.g., the display device 240) in the vehicle as well as an operation related to the application program. The controller 310 may process a signal, data, information, etc., input or output through the above-described components or drive the application program stored in the memory 350 to provide or process information or a function appropriate for the user. The controller 310 may control all or some of the components included in the display device 240 to drive the application program stored in the memory 350.

According to embodiments, the controller 310 may control the driving unit 360 to change a shape and/or a position of the display included in the display unit 331. To this end, the driving unit 360 may include a motor, a hinge, a gear, etc.

The controller 310 may control the display unit 331 to flexibly use the display according to a mode.

According to embodiments, the controller 310 may perform a function of an electronic control unit (ECU) or a function of an advanced driver assistance system (ADAS), or both functions. In the present disclosure, the controller 310 may be implemented as hardware using at least one of application specific integrated circuits (ASICs), digital signal processors (DSPs), digital signal processing devices (DSPDs), programmable logic devices (PLDs), field programmable gate arrays (FPGAs), controllers, microcontrollers, microprocessors, and other electrical units for performing functions.

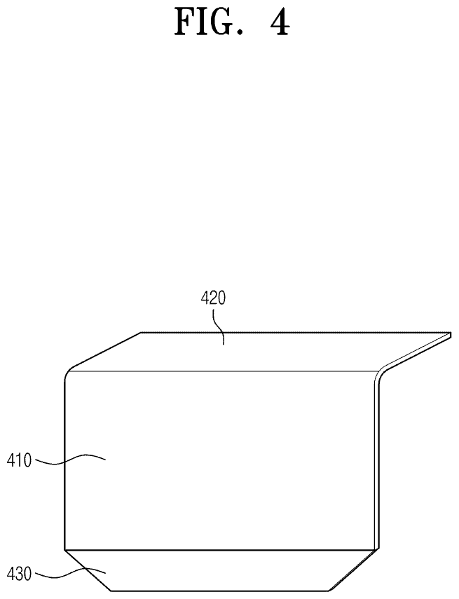

FIG. 4 shows an example of a display of a display device according to embodiments. The display device 240 may include the display unit 331 which may include a flexible display.

According to embodiments, the display may include a plurality of display areas. In the present disclosure, a description will be made of an embodiment in which the display is divided into three display areas. In the present disclosure, for convenience of a description, three display areas may include a first area 410, a second area 420, and a third area 430.

In an embodiment of the present disclosure, the first area 410 may be positioned between the second area 420 and the third area 430, and may be a main area that maintains a planar state at all times. The second area 420 and the third area 430 may be referred to as sub areas in which the display is foldable, i.e., is foldable or unfoldable at a specific angle.

According to embodiments, the first area 410 to the third area 430 may be implemented as separate touch screens or a single touch screen.

In the present disclosure, a surface of the first area 410 on which a touch screen is visible may be interpreted as a front surface, and a surface opposite to the front surface may be interpreted as a rear surface.

In the present disclosure, the first area 410 to the third area 430 may be arranged on the front surface, and especially, the second area 420 may be positioned above the first area 410 and the third area 430 may be positioned under the first area 410.

According to embodiments, the first area 410 to the third area 430 may have the same size or different sizes. In an embodiment of the present disclosure, among the first area 410 to the third area 430, the first area 410 has the largest size. The second area 420 and the third area 430 may have the same size or different sizes.

In the present disclosure, a state of a part of the display being bent at a specific angle may be referred to as a folded state, and a state of the part of the display being unfolded may be referred to as an unfolded state. In the present disclosure, the second area 420 and/or the third area 430 may be folded or unfolded at a specific angle.

In the present disclosure, the unfolded state may mean a state where the first area 410 and the second area 420 form an angle of 180 degrees (or about 180 degrees) or a state where the first area 410 to the third area 430 all form an angle of 180 degrees (or about 180 degrees). The unfolded state may also mean a state where the first area 410 and the second area 420 are arranged substantially flat or a state where the first area 410 to the third area 430 all are arranged substantially flat.

In the present disclosure, the folded state may mean a state where the second area 420 is folded at a specific angle with respect to the first area 410 and/or the third area 430 is folded at a specific angle with respect to the first area 410. An angle at which the second area 420 is bent and an angle at which the third area 430 is bent may be the same as or different from each other.

In the present disclosure, the second area 420 may be folded inwardly or outwardly with respect to the first area 410. The folding angle of the second area 420 may be fixed or manually determined by the user or may be automatically determined by determination of the controller 310. On the other hand, in an embodiment, the third area 430 may be folded inwardly with respect to the first area 410. The folding angle of the third area 430 may be fixed or manually determined by the user or may be automatically determined by determination of the controller 310.

In the present disclosure, outward folding may mean a state in which the second area 420 is bent outward to direct the touch screen of the first area 410 and the touch screen of the second area 420 opposite to each other. Inward folding may mean a state in which the second area 420 is folded at a specific angle to direct the touch screen of the first area 410 and the touch screen of the second area 420 inwardly (i.e., to the front surface) or a state in which the third area 430 is folded at a specific angle to direct the touch screen of the first area 410 and the touch screen of the third area 430 inwardly (i.e., the front surface).

According to embodiments, the display unit 331 may use the first area 410 to the third area 430 as independent screens according to a mode under control of the controller 310, or may combine at least two areas and use the combined area as a single screen. For example, all of the first area 410, the second area 420, and the third area 430 may be combined to form a single large screen.

According to embodiments, the display unit 331 may include a plurality of modes.

In the present disclosure, a basic mode (or an off mode) may refer to a mode when the display is in an off state, and an operation mode may refer to a mode when the display is in an on state.

In the present disclosure, when a display is in the off state, a vehicle's engine is not running or the vehicle's engine is running, but the display (or a display device) is turned off. When the vehicle engine is running, the off mode may be selected by the user.

In an embodiment, the operation mode may be divided into three modes. In the present disclosure, the three modes will be referred to as a first mode (or a mode A), a second mode (a mode B), and a third mode (a mode C). In the present disclosure, the number of modes is an example, and the present disclosure is not limited thereto.

In the present disclosure, the driving unit 360 may fold or unfold the second area 420 and/or the third area 430 at a specific angle according to a mode. The driving unit 360 may vertically slide the entire display according to a mode.

According to embodiments, the driving unit 360 may include a hinge that facilitates folding/unfolding of the second area 420 and/or the third area 430. In an embodiment, the hinge may be arranged between the first area 410 and the second area 420 and between the first area 410 and the third area 430 such that the second area 420 and/or the third area 430 maintains a set shape or a folding angle. That is, the first area 410 and the second area 420, and the first area 410 and the third area 430 may be connected to each other by the hinge.

According to embodiments, in the basic mode or the off state of the second area 420 (i.e., nothing is displayed), the second area 420 may be folded inwardly (i.e., to the front surface) or outwardly (i.e., to the rear surface), with respect to the first area 410, to ensure visibility of the driver in the driver's seat and/or the front occupant's seat of the vehicle.

According to a folding direction of the second area 420, i.e., whether the second area 420 is folded outwardly (i.e., out) or inwardly, the display may have an S shape or a C shape in the basic mode or the off state of the second area 420. In the present disclosure, outward folding will be referred to as out-folding, and inward folding will be referred to as in-folding.

In an embodiment of the present disclosure, when the second area 420 is in the on state (e.g., images, texts, graphics, etc., are displayed), the second area 420 may be folded inwardly with respect to the first area 410.

In an embodiment of the present disclosure, the second area 420 may be in the folded state in the first mode and in the unfolded state in the second mode and the third mode.

In an embodiment of the present disclosure, the third area 430 may be in the folded state in the first mode and the second mode and in the unfolded state in the third mode.

To sum up, both the second area 420 and the third area 430 are in the folded state in the first mode, the second area 420 may be in the unfolded state and the third area 430 may be in the folded state, in the second mode, and both the second area 420 and the third area 430 may be in the unfolded state in the third mode. In other words, in an embodiment of the present disclosure, the mode differs with the shape of the display.

According to embodiments, when the second area 420 is in the folded state, nothing (e.g., a black screen or a screen having a color such as a dashboard) may be displayed in the second area 420, or basic information, e.g., a welcome message, artificial intelligence (AI) communication, weather, current time, emergency information, interior video, etc., may be displayed. The above-listed basic information may be an example, and in the present disclosure, the basic information may be added, changed, or removed, and thus is not limited to the above-listed information.

According to embodiments, when the third area 430 is in the folded state, one or more soft buttons for performing specific functions may be displayed in the third area 430. The soft button may have an icon form and may have a graphic form indicating a function thereof. Alternatively, the soft buttons may be grouped in association with a specific function. According to the number of soft buttons, arrangements of the soft buttons, etc., the third area 430 may include one or more pages. In this case, selection of an arrow, an icon indicating the next page, etc., may allow movement to the next page. In the present disclosure, the soft button may be used as the same meaning as a virtual button.

For example, when the third area 430 is in the folded state, the third area 430 may include a vehicle control area (or an air conditioning control area) related to an air conditioner, a heater, etc., and one or more soft buttons for performing functions related to air conditioning may be arranged in the vehicle control area. For example, the user may adjust a wind direction, a wind volume, a temperature, etc., by touching one or more buttons in the vehicle control area. In another embodiment, a vehicle control button and a soft button for volume control may be further displayed in the third area 430.

In another example, when the third area 430 is in the unfolded state, i.e., in the third mode (i.e., an entertainment mode), a content control button for entertainment may be displayed in the third area 430.

In the present disclosure, the number, functions, arranged positions, etc., of soft buttons displayed in the third area 430 may be changed, added, or deleted.

According to embodiments, in the first mode, the first area 410 to the third area 430 may operate separately. That is, navigation information, main contents, etc., may be displayed in the first area 410, the basic information may be displayed in the folded state in the second area 420, and one or more soft buttons for vehicle control, air conditioning, etc., may be displayed in the folded state in the third area 430. In another example, in the first mode, nothing may be displayed in the first area 410.

According to embodiments, in the second mode, as the second area 420 is unfolded, the first area 410 and the second area 420 may be combined with each other as a single display area. The combined display area may operate separately from the third area 430. That is, in the combined display area, a single image, e.g., the navigation information, the main contents, etc., may be displayed in an expanded manner, and one or more soft buttons for vehicle control, air conditioning, etc., may be displayed in the third area 430 in the folded state. In another embodiment, in the second mode, as the second area 420 is unfolded, the first area 410 and the second area 420 are arranged in a flat state, but the first area 410 and the second area 420 may operate separately. In other words, the first area 410 to the third area 430 may operate separately. In this case, the navigation information, the main contents, etc., may be displayed in the first area 410, and the basic information may be displayed in the second area 420.

According to embodiments, in the third mode, as the second area 420 and the third area 430 are unfolded, the display may slide upwardly. In this case, the first area 410 to the third area 430 may be combined as a single display area. Then, contents may be displayed in the combined display area (i.e., a full screen). In the present disclosure, the contents may include a still image, a moving image, a TV program, a game, etc. In the third area 430, soft buttons for controlling playback of contents or displaying a content state may be displayed. In the present disclosure, a third mode in which the first area 410 to the third area 430 may be combined to form a single large screen (i.e., a full screen) and contents are displayed through the large screen will be referred to as an entertainment mode.

In the third mode 430, as the display including the first area 410 to the third area 430 slides upwardly, an area hidden by the third area 430 may be exposed, and in the present disclosure, this area will be referred to as a hidden area or a hidden button area.

In an embodiment, in the present disclosure, the hidden area may include at least one hard button. A specific function of the vehicle and/or a specific function of the display may be performed by at least one hard button of the hidden area. The hard button may mean a button having fixed position and size. In the present disclosure, the hard button of the hidden area may be referred to as a physical button.

In another embodiment, the hidden area may be provided in the form of a display in the present disclosure. The display in the hidden area may display at least one soft button to enable the specific function of the vehicle and/or the specific function of the display to be executed. The soft button may refer to a button provided as a touch type on the screen of the display. The shape of the soft button in the hidden area may be changed variously according to a use condition or need of the display, unlike the hard button. When the hidden area is provided in the form of a display, for convenience of description, the display having the foldable function will be referred to as a first display and the display in the hidden area will be referred to as a second display, in the present disclosure.

In the present disclosure, the hidden area will be referred to as a hard button area when the hidden area includes one or more hard buttons, and the hidden area will be referred to as a soft button area when the hidden area has the form of a display.

In the present disclosure, selection of the first mode, the second mode, and the third mode may be performed manually by the user, and may be performed automatically by the controller 310 according to a state of the vehicle. Alternatively, according to user's selection, a mode may he changed in the controller 310.

For example, when the display in the off mode, the first mode may be selected by control by the controller 310, and when the vehicle is in a normal driving mode, the first mode or the second mode may be selected by control by the controller 310. The controller 310 may control the third mode to be selected in a parking, stopping, or autonomous driving mode.

As such, in the present disclosure, the third mode may be referred to as an entertainment mode, and during parking, autonomous driving, and stopping, the second area 420 and the third area 430 may be unfolded and at the same time, the display including the first area 410 to the third area 430 may rise upwardly through sliding, thus changing the shape and position of the display. That is, as the second area 420 and the third area 430 are unfolded, the display area may be extended to the full screen (i.e., a single large screen), and as the display rises upwardly, the hidden area may appear (or may be exposed).

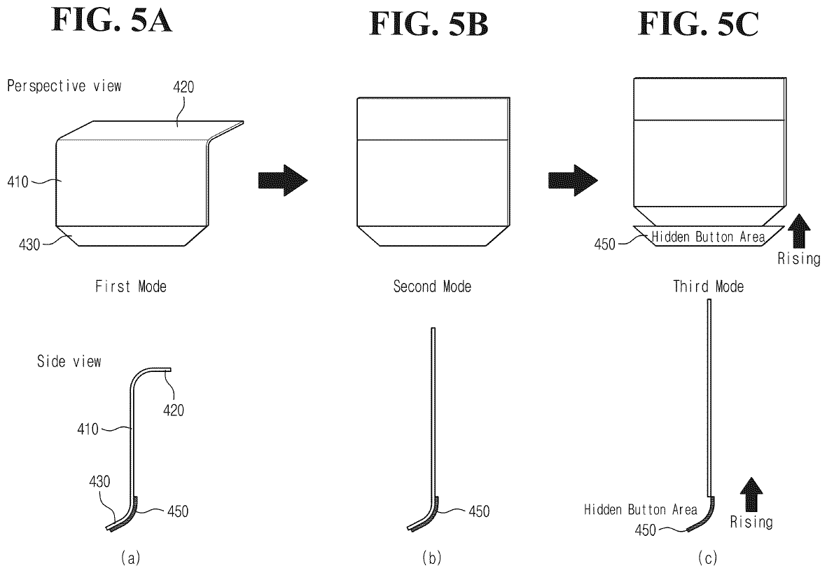

FIG. 5A to FIG. 5C show examples of shape (or form) change and position change of a display in the first to third modes. In the present disclosure, to avoid redundant description, some description may be omitted from FIG. 5A to FIG. 5C. Therefore, the description omitted from FIG. 5A to FIG. 5C will refer to the description of FIG. 2 to FIG. 4.

In FIG. 5A to FIG. 5C, an upper side shows perspective views of the first area 410 to the third area 430 of the display having a shape changing with a mode, and a lower side shows side views of the first area 410 to the third area 430 of the display having the shape changing with the mode.

More specifically, FIG. 5A shows an example in the first mode in which both the second area 420 and the third area 430 are in the folded state with respect to the first area 410 and a hidden area 450 is hidden by the third area 430. That is, as the third area 430 hides the hidden area 450, the user in the driver's seat and/or the front occupant's seat of the vehicle may not see the hidden area 450 due to the third area 430. An angle at which the second area 420 is folded and an angle at which the third area 430 is folded may be the same as or different from each other.

FIG. 5B shows an example in the first mode in which the second area 420 is in the unfolded state with respect to the first area 410, the third area 430 is in the folded state, and the hidden area 450 is hidden by the third area 430. That is, also in the second mode, as the third area 430 hides the hidden area 450, the user in the driver's seat and/or the front occupant's seat of the vehicle may not see the hidden area 450 due to the third area 430. In this case, the first area 410 and the second area 420 may be arranged substantially flat to form a single display area (i.e., a display screen) or separate display areas.

FIG. 5C shows an example in the third mode in which both the second area 420 and the third area 430 are in the unfolded state with respect to the first area 410, and the display including the first area 410 to the third area 430 slides upwardly. In this case, a sliding distance may be fixed to a specific value or may be selected by the user. That is, as the display rises upwardly through sliding, the hidden area 450 hidden by the third area 430 may be exposed. In other words, the user in the driver's seat and/or the front occupant's seat of the vehicle may see the hidden area 450 hidden by the third area 430. In this case, the third area 410 to the third area 430 may be arranged substantially flat to form a single display area (i.e., the display screen). That is, in the third mode, a large screen may be formed.

In the first mode and the second mode according to the present disclosure, the shape (or form) of the display may be changed, but in the third mode, the shape and the position of the display may be changed.

As such, in the present disclosure, the shape (or form) and/or position of the display may be changed according to the mode. According to the mode, the hidden area 450 may be exposed or may not be exposed. In the present disclosure, the first to third modes may be classified into a mode in which the hidden area 450 is exposed and a mode in which the hidden area 450 is not exposed. In the present disclosure, a mode in which the hidden area 450 is exposed will be briefly referred to as an exposure mode, and a mode in which the hidden area 450 is not exposed will be briefly referred to as a non-exposure mode.

For example, when the mode of the flexible display is changed from the first/second mode to the third mode, the hidden area 450 may be exposed; when the mode is changed from the third mode to the first/second mode, the hidden area 450 may be hidden by the third area 430 and thus may not be visible. In the present disclosure, the first mode and the second mode will be referred to as modes (or the non-exposure modes) where the hidden area 450 is not exposed, and the third mode will be referred to as a mode (or the exposure mode) where the hidden area 450 is exposed. In the present disclosure, the first mode and the second mode will be used interchangeably with the modes in which the hidden area 450 is not exposed, and the third mode will be used interchangeably with the mode in which the hidden area 450 is exposed.

In the present disclosure, when mode change occurs from the mode in which the hidden area 450 is exposed to the mode in which the hidden area 450 is not exposed, or from the mode in which the hidden area 450 is not exposed to the mode in which the hidden area 450 is exposed, arrangements (or positions) of buttons of the hidden area 450 and arrangements (or positions) of buttons displayed in the third area 430 of the flexible display may be provided identically. In the present disclosure, the size of the buttons of the hidden area 450 and the size of the buttons displayed in the third area 430 of the flexible display may be provided identically. In the present disclosure, a control state of the buttons of the hidden area 450 and a control state of the buttons displayed in the third area 430 of the flexible display may be provided identically. In the present disclosure, the control state may include a temperature, an on/off state of each function, a setting state, etc.

That is, in the present disclosure, when mode change occurs from the mode in which the hidden area 450 is exposed to the mode in which the hidden area 450 is not exposed, or from the mode in which the hidden area 450 is not exposed to the mode in which the hidden area 450 is exposed, at least one of arrangements (or positions), sizes, and control states of the buttons of the hidden area 450 and arrangements (or positions), sizes, and control states of the buttons displayed in the third area 430 of the flexible display may be provided identically, under control of the controller 310.

As such, in an embodiment of the present disclosure, when mode change occurs from the third mode to the first/second mode, that is, to the mode in which the hidden area 450 is not exposed, arrangements (or positions) and control state of the buttons of the hidden area 450 may be displayed identically in the third area 430 of the flexible display. To this end, in an embodiment, during the third mode, arrangements (or positions) and sizes of the buttons of the hidden area 450, and/or the control state of each button may be stored in the memory 350. That is, the positions (or arrangements), control states, and/or sizes (e.g., sizes of the buttons) of the buttons of the hidden area 450 may be identically displayed in the third area 430.

The hidden area 450 may be a hard button area including hard buttons or a soft button area in the form of a display including soft buttons.

In the present disclosure, in case of mode change from the first/second mode to the third mode, i.e., to the mode in which the hidden area 450 is exposed, at least one of arrangements (i.e., positions) and control states of the soft buttons displayed in the third area 430 may be identically displayed or applied in the hidden area 450. To this end, in an embodiment, during the first mode or the second mode, arrangements (or positions) and size of the soft buttons of the third area 430, and/or the control state of each button may be stored in the memory 350.

For example, when the hidden area 450 is a hard button area, the control state of the soft buttons displayed in the third area 430 may be applied to the hard buttons of the hidden area 450.

In another example, when the hidden area 450 is a soft button area, arrangements (or positions), sizes (e.g., sizes of the buttons), and control states of the soft buttons displayed in the third area 430 may be identically displayed in the display in the hidden area 450.

In case of change from the mode in which the hidden area 450 is exposed to the mode in which the hidden area 450 is not exposed or from the mode in which the hidden area 450 is not exposed to the mode in which the hidden area 450 is exposed, continuous use may be provided to the driver to facilitate user's vehicle control.

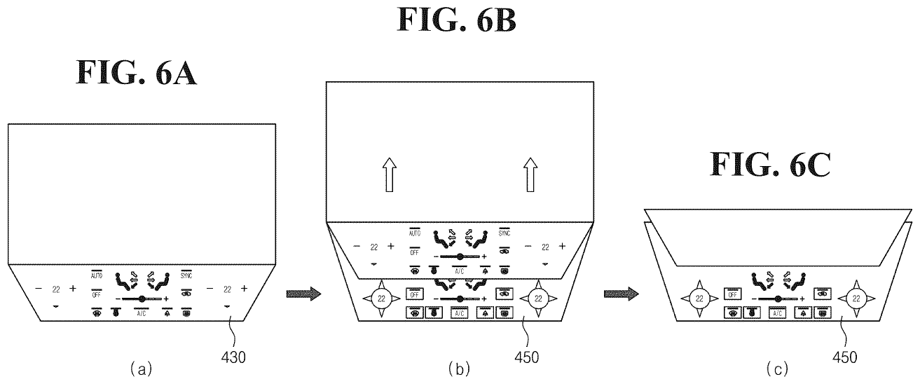

FIG. 6A to FIG. 6C show an example in which information of a hidden area and information of a partial area of a flexible display are associated with each other in mode change, according to embodiments.

FIG. 6A shows an example of arrangements of the soft buttons displayed in the third area 430 in the first mode or the second mode. In FIG. 6A, the hidden area 450 may not be exposed by being hidden by the third area 430.

That is, the third area 430 of the flexible display is an area that may be easily reached and manipulated by a driver's hand, and may mainly display a vehicle-related function. For example, soft buttons for air conditioning, volume, sheet control, etc., may be displayed. In this case, the soft button may have an icon form and may have a graphic form indicating a function thereof.

More specifically, in the present disclosure, the third area 430 may include a vehicle control area related to an air conditioner, a heater, etc., as shown in FIG. 6A, and one or more soft buttons for performing functions related to air conditioning may be arranged in the vehicle control area. For example, the user may adjust a wind direction, a wind volume, a temperature, etc., by touching one or more buttons in the vehicle control area. In the present disclosure, the vehicle control area may be the entire third area 430 and a part of the third area 430. According to embodiments, the vehicle control area may further include soft buttons such as media, a hot wire, etc.

As shown in FIG. 6B, when the mode of the flexible display changes from the first mode or the second mode to the third mode, the driving unit 360 may operate under control of the controller 310, and as the flexible display rises (or slides) upwardly, the hidden area 450 may be exposed. In this case, as the second area 420 and the third area 430 are unfolded, the display area may be extended to a full screen (i.e., a single large screen) and the vehicle control area displayed in the third area 430, i.e., soft buttons related to vehicle control may disappear.

In the present disclosure, upon mode change of the flexible display from the first mode or the second mode to the third mode as shown in FIG. 6B, the controller 310 may control the display unit 331 and the memory 350 to display arrangements, sizes, and control states of the soft buttons of the vehicle control area displayed in the third area 430 to be identically displayed in the hidden area 450 as shown in FIG. 6C.

This is an embodiment, and some soft buttons of the third area 430 may be reflected in the hidden area 450. For example, at least one of arrangements, sizes, and control states of buttons having essential functions or high priorities among the soft buttons of the third area 430 may be applied to the hidden area 450.

In other words, all of position, size, and state of air-conditioning buttons displayed in the third area 430 may be identically provided as hard buttons or soft buttons of the hidden area 450. A control state (e.g., temperature, on/off state of each function, setting state) of each soft button of the third area 430 may be reflected and displayed in the hidden area 450.

When the hidden area 450 is a hard button area and at this time, the position of the hard buttons is fixed and thus is difficult to change, control state information of the third area 430 may be reflected into the hidden area 450.

When the hidden area 450 is in the form of a display, the hidden area 450 may include soft buttons such that arrangements, sizes, control states, etc., of the soft buttons of the third area 430 may be identically reflected into the hidden area 450.

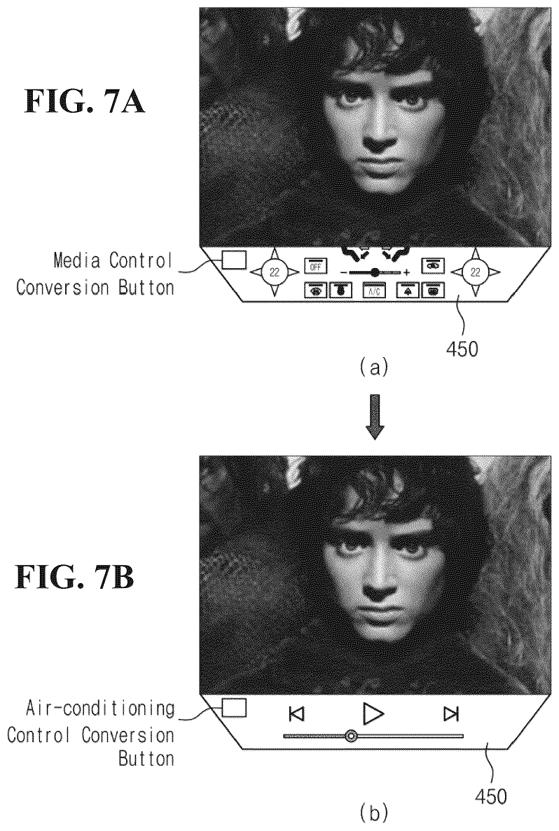

FIG. 7A and FIG. 7B show embodiments for a case where a hidden area is provided in the form of a display, in the present disclosure.

In an embodiment, when the hidden area 450 is provided in the form of a display, the degree of freedom for size, form, and position of various buttons when compared to hard buttons may increase, such that the same arrangement, size, and control state as the buttons of the vehicle control area of the third area 430 may be displayed in the display in the hidden area 450 as shown in FIG. 7A.

That is, when a vehicle control button (e.g., an essential control button such as air conditioning, media, heat wire, etc. ,) is provided, the vehicle control button may be a fixed button such that the same arrangement, size, and control state as the soft buttons of the vehicle control area of the third area 430 may be displayed in the display in the hidden area 450.

In another embodiment, content control buttons for temporarily controlling the flexible display (or the front display) through a specific gesture or a button input may be displayed in the hidden area 450, as shown in FIG. 7B. That is, as the flexible display moves upward (i.e., the hidden area 450 is exposed), the first area 410 to the third area 430 of the flexible display may operate as the full screen and contents (or media contents) may be reproduced. In this case, media content control buttons (e.g., play, fast wind, time bar, etc.) may be provided in the display in the hidden area 450. That is, the hidden area 450 may be used as a content control area. In this way, contents reproduced on the full screen may be controlled without hiding the flexible display, i.e., the full screen on which the contents are reproduced.

That is, in the present disclosure, when the hidden area 450 is implemented as the display, the hidden area 450 may be used as the vehicle control area or the media content control area. In the present disclosure, the hidden area 450 may further display a soft button for conversion in the hidden area 450 for conversion from the vehicle control area to the media content control area or from the media content control area to the vehicle control area. In the present disclosure, the soft button for conversion may be referred to as a conversion button.

When the hidden area 450 is used as the vehicle control area as shown in FIG. 7A, the conversion button may be displayed as a media content conversion button; when the hidden area 450 is used as the media content control area as shown in FIG. 7B, the conversion button may be displayed as an air conditioning conversion button. This is merely an embodiment, and the name of the conversion button may be changed, modified, etc.

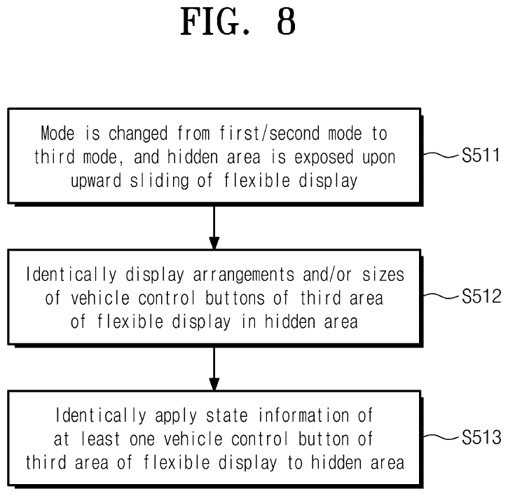

FIG. 8 is a flowchart of an example in which information of a hidden area and information of a partial area of a flexible display are associated with each other, according to embodiments. FIG. 8 shows an example in which the hidden area 450 is provided as hard buttons or in the form of a display.

When the mode of the flexible display is changed from the first/second mode to the third mode, the driving unit 360 may operate under control of the controller 310 such that the flexible display may slide (i.e., rise) upwardly and thus the hidden area 450 may be exposed, as shown in FIG. 6B, in operation S511. In this case, the first area 410 to the third area 430 of the flexible display may be changed into a single full screen and thus contents (e.g., video contents or music contents) may be reproduced, and arrangements (or positions) and/or sizes of the soft buttons displayed in the third area 430 may be identically displayed in the hidden area 450 as shown in FIG. 6C, in operation S512. To this end, during an operation of the flexible display in the first mode or the second mode, arrangements and/or sizes of the soft buttons of the third area 430 and state information of each button may be stored in the memory 350. Upon change to the third mode, the controller 310 may control the display unit 331 and the memory 350 to identically display arrangements (or positions) and/or sizes of at least one soft button displayed in the third area 430.

The controller 310 may control the display unit 331 and the memory 350 to identically apply state information (e.g., temperature, wind direction, etc.) of at least one button of the third area 430 to the hidden area 450, in operation S513.

In addition, in the present disclosure, when the hidden area 450 is implemented as the display, the hidden area 450 may be used as the vehicle control area or the media content control area as shown in FIG. 7A and FIG. 7B. A detailed description will refer to FIG. 7A and FIG. 7B and is omitted at this time.

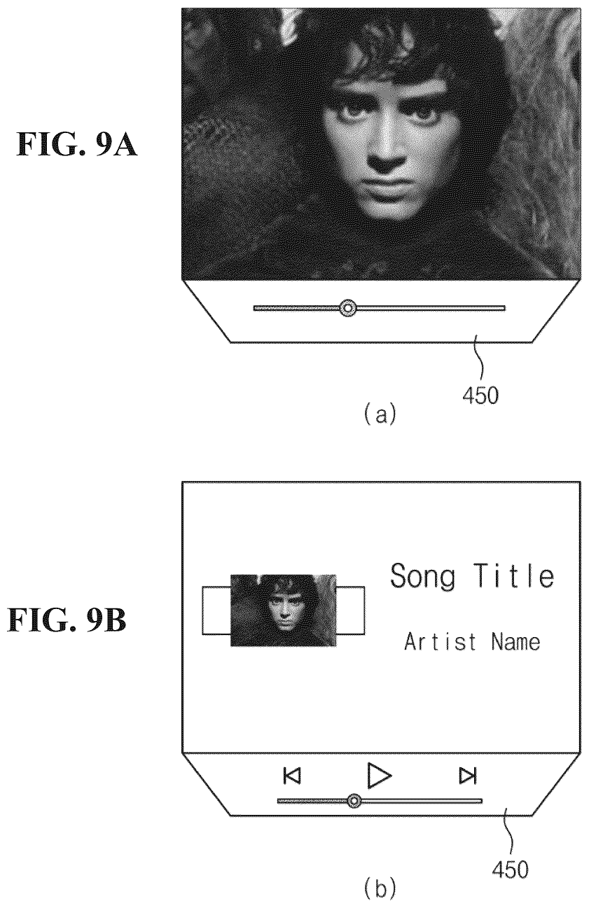

FIG. 9A and FIG. 9B show other embodiments for a case where a hidden area is provided in the form of a display, in the present disclosure.

That is, when it is not necessary to provide the vehicle control button (an essential control button such as air conditioning, media, heat wire, etc.) to the hidden area 450, there is no button necessarily fixed, such that the buttons of the display in the hidden area 450 may be changed according to the nature of contents provided in the flexible display. For example, when the video contents are reproduced in the flexible display as shown in FIG. 9A, the hidden area 450 may display a time bar, a volume, etc., capable of indicating or controlling a reproduction state of the video contents. In another example, as shown in FIG. 9B, when the music contents are reproduced in the flexible display, the hidden area 450 may display movement to previous/next songs, volume, etc.

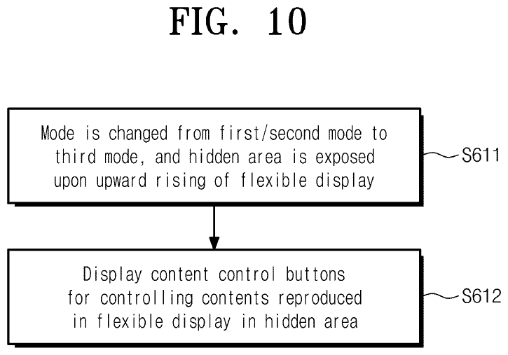

FIG. 10 is a flowchart of another example in which information of a hidden area and information of a partial area of a flexible display are associated with each other, according to embodiments. FIG. 10 shows an example in which the hidden area 450 is provided in the form of a display. In particular, FIG. 10 shows a method of using the hidden area 450 when it is not necessary to provide the vehicle control button in the hidden area 450.

When the mode of the flexible display is changed from the first/second mode to the third mode, the driving unit 360 may operate under control of the controller 310 such that the flexible display may slide (i.e., rise) upwardly and thus the hidden area 450 may be exposed, in operation S611. When the first area 410 to the third area 430 of the flexible display are changed into a single full screen to reproduce contents, buttons of the display in the hidden area 450 may be changed and displayed according to the nature of the reproduced contents, in operation S612. For example, when the video contents are reproduced in the flexible display as shown in FIG. 9A, the hidden area 450 may display a time bar, a volume, etc., capable of indicating a reproduction state of the video contents. In another example, as shown in FIG. 9B, when the music contents are reproduced in the flexible display, the hidden area 450 may display movement to previous/next songs, volume, etc.

So far, a description has been made of embodiments when mode change occurs from the first/second mode where the hidden area 450 is not exposed to the third mode where the hidden area 450 is exposed.

Next, a description will be made of embodiments when the mode of the flexible mode changes from the third mode in which the hidden area 450 is exposed to the first mode or the second mode where the hidden area 450 is not exposed.

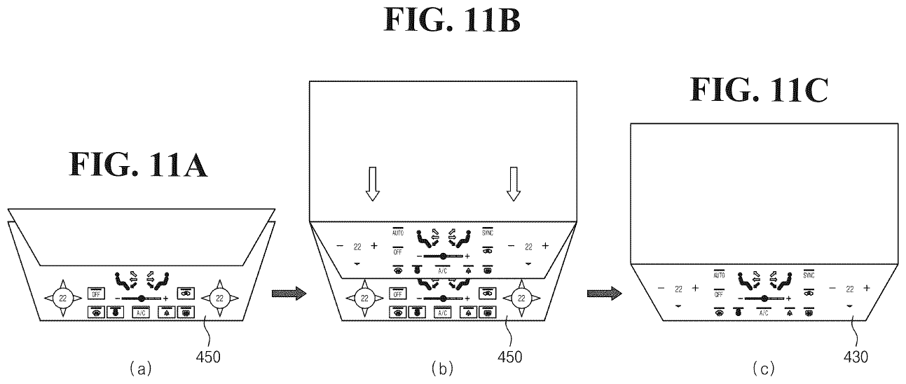

FIG. 11A to FIG. 11C show another example in which information of a hidden area and information of a partial area of a flexible display are associated with each other in mode change, according to embodiments.

FIG. 11A shows an example of arrangements of buttons displayed in the hidden area 450 in the third mode. The buttons displayed in the hidden area 450 may be hard buttons, or soft buttons displayed in the display.

According to embodiments, the hidden area 450 may include a vehicle control area related to an air conditioner, a heater, etc., as shown in FIG. 11A, and one or more soft buttons for performing functions related to air conditioning may be arranged in the vehicle control area. For example, the user may adjust a wind direction, a wind volume, a temperature, etc., by touching one or more buttons in the vehicle control area. In the present disclosure, the vehicle control area may be the entire hidden area 450 and a part of the hidden area 450. According to embodiments, the vehicle control area may further include soft buttons such as media, a hot wire, etc.

As shown in FIG. 11B, upon change from the third mode into the first mode or the second mode, the driving unit 360 may operate under control of the controller 310 such that the flexible display may slide downwardly and thus the hidden area 450 may be hidden. That is, the hidden area 450 may be invisible by being hidden by the third area 430. In this case, the third area 430 may be folded.

In the present disclosure, upon mode change of the flexible display from the third mode to the first/second mode as shown in FIG. 11B, the controller 310 may control the display unit 331 and the memory 350 to display arrangements, sizes, and control states of the soft buttons of the vehicle control area displayed in the hidden area 450 to be identically displayed in the third area 430 as shown in FIG. 11C.

This is an embodiment, and some buttons of the hidden area 450 may be reflected in the third area 430. For example, at least one of arrangements, sizes, and control states (e.g., a temperature, an on/off state of each function, a setting state) of buttons having essential functions or high priorities among the buttons of the hidden area 450 may be applied to the third area 430.

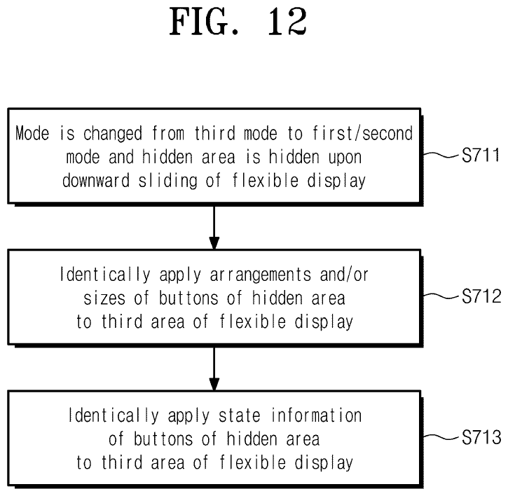

FIG. 12 is a flowchart of another example in which information of a hidden area and information of a partial area of a flexible display are associated with each other, according to embodiments. FIG. 12 shows an example in which the hidden area 450 is provided as hard buttons, or soft buttons in the form of a display.

That is, when the mode of the flexible display is changed from the third mode into the first/second mode, the driving unit 360 may operate under control of the controller 310 such that the flexible display may slide downwardly and thus the hidden area 450 may be hidden by the third area 430, as shown in FIG. 11B, in operation S711. In this case, arrangements (or positions) and/or sizes of buttons of the hidden area 450 may be identically displayed in the third area 430, as shown in FIG. 11C, in operation S512. To this end, during an operation of the flexible display in the third mode, arrangements and/or sizes of the buttons of the hidden area 450 and state information of each button may be stored in the memory 350. Upon change from the third mode to the first mode or the second mode, the controller 310 may control the display unit 331 and the memory 350 to identically display arrangements (or positions) and/or sizes of at least one button of the hidden area 450 in the third area 430.

The controller 310 may also control the display unit 331 and the memory 350 to identically apply state information (e.g., temperature, wind direction, etc.) of at least one button of the hidden area 450 to the third area 430, in operation S713.

As such, in the present disclosure, upon change from the first/second mode to the third mode or from the third mode to the first/second mode, buttons of the third area 430 and buttons of the hidden area 450 may be provided at the same position and with the same size, thereby providing the same usability regardless of the nature of the buttons (hard buttons ↔ soft buttons) in spite of movement of the flexible display. In particular, when the hidden area 450 is provided as the display, the configurations and arrangements of the buttons may be possible with a high degree of freedom.

The vehicle control apparatus and the control method thereof according to embodiments may improve usability of the display by changing the shape or position of the display according to a mode.

The vehicle control apparatus and the control method thereof according to embodiments may provide the user with convenience by appropriately controlling the size of the display area according to a mode.

The vehicle control apparatus and the control method thereof according to embodiments may conveniently change the size of the screen to be displayed and save the space, by folding or unfolding a part of the display according to a purpose for use. That is, the view of the driver and/or the occupant may not be obstructed by folding a part of the display according to a purpose for use, or the display with the large screen may be implemented by entirely unfolding the display.

The vehicle control apparatus and the control method thereof according to embodiments may expose the hidden area hidden by a part of the display by raising the display through sliding according to a mode for conversion into the entertainment mode, such that a part of the vehicle control function disappearing from the screen may be performed using the buttons of the hidden area.

In the vehicle control apparatus and the control method thereof according to embodiments, in the flexible display structure where the hidden area is exposed through sliding of the display, upon mode change from the mode where the hidden area is exposed to the mode where the hidden area is not exposed or from the mode where the hidden area is not exposed to the mode where the hidden area is exposed, arrangements/sizes of the buttons of the hidden area and arrangements/sizes of the buttons displayed in a specific area of the flexible display are provided identically, thereby providing continuous use and thus facilitating the driver's manipulation during driving.

In addition to the technical effects explicitly mentioned above, effects that are obvious to those of ordinary skill in the art may also be inferred from the entire description of the present specification.

Each part, module or unit described above may be software, processor or hardware parts that execute sequential execution processes stored in a memory (or storage unit). Each operation described in the foregoing embodiment may be performed by processor, software, and hardware parts. Each module/block/unit described in the above-described embodiment may operate as a processor, software, or hardware. Additionally, the methods presented in the embodiments may be implemented as code. This code may be written to a processor-readable storage medium and may therefore be read by a processor provided by the apparatus.

Although the present specification has been described for each drawing separately for convenience of a description, it is also possible to design a new embodiment by combining the embodiments described in each drawing. In addition, it is also within the scope of the present disclosure to design a computer-readable recording medium having recorded thereon a program for executing the previously described embodiments, as required by those of ordinary skill in the art.

The apparatus and method according to the present disclosure are not limitedly applied to the configuration and method of the embodiments described above, but the embodiments may be configured by selectively combining all or part of the embodiments such that various modifications can be made.

In the present disclosure, terms such as first, second, etc. may be used to describe various components of the present disclosure. However, various components according to the present disclosure should not be limited in interpretation by the foregoing terms. These terms are only used to distinguish one component from another. For example, a first user input signal may be referred to as a second user input signal. Similarly, the second user input signal may be referred to as the first user input signal. Any use of these terms should be construed as not departing from the scope of the various embodiments. Although both the first user input signal and the second user input signal are user input signals, they do not mean the same user input signals unless the context clearly indicates otherwise.

The terminology used to describe the present disclosure is for the purpose of describing particular embodiments only and is not intended to be limiting of the embodiments. As used in the description of the embodiments and in the claims, the singular is intended to include the plural unless the context clearly dictates otherwise. Additionally, the expression “and/or” is used to mean all possible combinations of terms. The expression “include” describes the presence of features, numbers, operations, elements, and/or components, but does not imply the exclusion of additional features, numbers, operations, elements, and/or components. Conditional expressions such as in case that, when, etc., used to describe the present disclosure are not to be interpreted as being limited to only optional cases. When certain conditions are satisfied, it is intended that a related operation be performed in response to certain conditions, or that a related definition be interpreted.

What is claimed is:

1. A vehicle control apparatus comprising:
a body providing controls for systems of a vehicle; and
a display device provided in the body,
wherein the display device comprises:
a display configured to display visual information; and
a driving unit configured to change at least one of a shape of the display and a position of the display according to a mode of the display device,
wherein the body further comprises a hidden area that is selectively covered by a lower portion of the display,
the driving unit selectively covers and uncovers the hidden area by changing the position of the display,
modes of the display device comprise an exposure mode in which the hidden area is exposed and a non-exposure mode in which the hidden area is not exposed, and
an arrangement of one or more buttons in the hidden area in the exposure mode are identical to an arrangement of one or more buttons of the lower portion of the display that covers the hidden area in the non-exposure mode.

2. The vehicle control apparatus of claim 1, wherein, when the mode is changed from the exposure mode to the non-exposure mode, the one or more buttons of the lower portion of the display are arranged identically to the the one or more buttons of the hidden area.

3. The vehicle control apparatus of claim 2, wherein state information of the one or more buttons of the hidden area is applied to the one or more buttons of the lower portion of the display.

4. The vehicle control apparatus of claim 1, wherein, when the mode is changed from the non-exposure mode to the exposure mode, the one or more buttons of the hidden area are arranged identically to the one or more buttons of the lower portion of the display.

5. The vehicle control apparatus of claim 4, wherein state information of the one or more buttons of the lower portion of the display is applied to the one or more buttons of the hidden area.

6. The vehicle control apparatus of claim 1, wherein sizes of the one or more buttons of the hidden area in the exposure mode are identical to sizes of the one or more buttons of the lower portion of the display in the non-exposure mode.

7. The vehicle control apparatus of claim 1, wherein the hidden area comprises one or more hard buttons or one or more soft buttons for controlling a function of the systems of the vehicle.

8. The vehicle control apparatus of claim 1, wherein the hidden area comprises one or more hard buttons or one or more soft buttons for controlling content reproduced on the display.

9. The vehicle control apparatus of claim 1, wherein the driving unit is further configured to change the shape of the display by folding or unfolding a part of the display at a specific angle according to the mode, and to change the position of the display by moving the display upwardly or downwardly through sliding.

10. The vehicle control apparatus of claim 9, wherein a display area of the display is divided into a first area, a second area, and a third area arranged on a same surface,
the second area is positioned above the first area, and the third area is positioned under the first area, and
at least one of the second area and the third area is folded or unfolded at a specific angle by the driving unit.

11. The vehicle control apparatus of claim 10, wherein the lower portion of the display where the one or more buttons are displayed corresponds to the third area.

12. The vehicle control apparatus of claim 10, wherein the third area is in a folded state in the non-exposure mode,
the third area is in an unfolded state in the exposure mode,
when the mode of the display is changed from the non-exposure mode to the exposure mode, the display moves upwardly by a specific distance through sliding, and
when the mode of the display is changed from the exposure mode to the non-exposure mode, the display moves downwardly by a specific distance through sliding.

13. A vehicle control method comprising:
providing a display and a hidden area that is covered by a lower area of a display in a non-exposure mode, the display and hidden area disposed in a body providing controls for systems of a vehicle; and
changing at least one of a shape of the display and a position of the display according to a mode of the display; and
wherein changing the position of the display selectively exposes or conceals the hidden area,
wherein modes of the display comprise an exposure mode in which the hidden area is exposed and a non-exposure mode in which the hidden area is covered, and
an arrangement of one or more buttons of the hidden area in the exposure mode is identical to an arrangement of one or more buttons of the lower area of the display in the non-exposure mode.

14. The method of claim 13, wherein, when the mode is changed from the exposure mode to the non-exposure mode, the one or more buttons of the lower area of the display are arranged identically to the one or more buttons of the hidden area.

15. The method of claim 14, wherein state information of the one or more buttons of the hidden area is applied to the one or more buttons of the lower area of the display.

16. The method of claim 13, wherein, when the mode is changed from the non-exposure mode to the exposure mode, the one or more buttons of the hidden area are arranged identically to the one or more buttons of the lower area of the display.

17. The method of claim 16, wherein state information of the one or more buttons of the lower area of the display is applied to the one or more buttons of the hidden area.

18. The method of claim 13, wherein sizes of the one or more buttons of the hidden area in the exposure mode are identical to sizes of the one or more buttons of the lower area of the display in the non-exposure mode.

19. The method of claim 13, wherein the hidden area comprises one or more hard buttons or one or more soft buttons for controlling a function of the systems of the vehicle.

20. The method of claim 13, wherein the hidden area comprises one or more hard buttons or one or more soft buttons for controlling content reproduced on the display.

21. The method of claim 13, wherein the shape of the display is changed by folding or unfolding a part of the display at a specific angle according to the mode, and
the position of the display is changed by moving the display upwardly or downwardly through sliding.

22. The method of claim 21, wherein a display area of the display is divided into a first area, a second area, and a third area arranged on a same surface,
the second area is positioned above the first area, and the third area is positioned under the first area, and
at least one of the second area and the third area is folded or unfolded at a specific angle.

23. The method of claim 22, wherein a lower area of the display where the one or more buttons are displayed corresponds to the third area.

24. The method of claim 22, wherein the third area is in a folded state in the non-exposure mode,
the third area is in an unfolded state in the exposure mode,
when the mode of the display is changed from the non-exposure mode to the exposure mode, the display moves upwardly a specific distance through sliding, and
when the mode of the display is changed from the exposure mode to the non-exposure mode, the display moves downwardly a specific distance through sliding.

25. A computer-readable recording medium having a computer program stored thereon, which, when executed by a processor alone or in connection with another processor, executes the method of claim 13.
